(19) United States
(12) Patent Application Publication
(10) Pub. No.: US 2010/0158018 A1
(43) Pub. Date: Jun. 24, 2010

(54) METHOD FOR FORWARDING PATH VIRTUALIZATION FOR ROUTER

(75) Inventors: Wang Bong Lee, Daejeon (KR); Kyoung Soon Kang, Daejeon (KR); Ki Cheol Jeon, Daejeon (KR); Tae II Kim, Daejeon (KR); Boo Geum Jung, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and TelecommunIcations Research Instutute, Daejeon (KR)

(21) Appl. No.: 12/505,646

(22) Filed: Jul. 20, 2009

(30) Foreign Application Priority Data
Dec. 19, 2008 (KR) 10-2008-0130480

(51) Int. Cl. H04L 12/28

(52) U.S. Cl. 370/395.53

(57) ABSTRACT

Provided is a method for forwarding path virtualization for a router, which prevents the processing speed of the router from decreasing due to a plurality of operating systems installed in an upper layer of a hypervisor when the router is virtualized.

### CROSS-REFERENCE TO RELATED APPLICATION

This application claims the benefit of Korean Application No. 10-2008-0130480, filed on Dec. 19, 2008 in the Korean Intellectual Property Office, the disclosure of which is incorporated herein by reference.

### BACKGROUND OF THE INVENTION

1. Field of the Invention

The present invention relates to a method of virtualizing for a router and, more particularly, to a method for forwarding path virtualization for a router, which applies para-virtualization for a router in which a plurality of operating systems are installed and performs policy control on a forwarding engine included in the router so as to increase the processing speed of the router.

The present invention is derived from a study conducted as a part of the development of the technology of driving forces behind IT growth by the Ministry of Information and Communication and the Institute for Information Technology Advancement [Project Management No. 2006-S-061-03, Project Title: Development of IPv6 based QoS service and terminal mobility supporting router technology].

2. Discussion of the Related Art

Virtualization in computer technology is a technique which logically splits a single physical resource or logically integrates different physical resources. Generally, the virtualization means separation of actual resources from resources seen by users.

Although the virtualization technique started with virtual memories in late 1960 and has been spread, the virtualization is restrictively used because of high installation cost and limited environment in which the virtualization is used.

The virtualization has been developed for the past decades and reached a hypervisor supporting segmentation of dynamic resources.

The virtualization can be classified into hardware virtualization, operating system virtualization, application virtualization, etc. according to application field. Otherwise, the virtualization may be classified into storage virtualization, server virtualization, network virtualization and service virtualization according to technical standard to which the virtualization is applied.

The network virtualization means virtualization for resources which physically connect an application or a server to other virtual resources.

A user can pool and share network components to construct a communication system that is more efficient, cost-effect and stable for IT infrastructure by virtualizing a network. Particularly, a virtualized network can provide an environment suited to experiment on new architecture or new service which makes up for problems of the current Internet.

It is desirable to virtualize a router when the router manages bandwidths through network virtualization. Now, virtualization on IP addresses, LAN and network adapters among resources available in the router is partially in progress and applied to a security field.

Conventional virtualization for a router uses a hypervisor for virtualizing the operating system of the router and the hypervisor uses full virtualization that emulates resources of the router, particularly, hardware resources.

If multiple operating systems are installed in the router, it is required that a forwarding plane and a routing plane for each operating system are arranged in an upper layer of the hypervisor and each operating system accesses resources emulated by the hypervisor in the conventional full virtualization.

The multiple operating systems which access the resources through the hypervisor must share the overall resources of the router, emulate the resources and independently operate. Furthermore, the performance of the router is remarkably deteriorated because the forwarding plane and the routing plane for each operating system are located in the upper layer of the hypervisor.

### SUMMARY OF THE INVENTION

It is an object of the present invention to provide a method for forwarding path virtualization for a router, which prevents the processing speed of the router from decreasing due to a plurality of operating systems installed in an upper layer of a hypervisor when the router is virtualized.

According to an aspect of the present invention, there is provided a method for forwarding path virtualization for a router, which comprises setting a resource using schedule with respect to a forwarding engine of the router for each of a plurality of operating systems, and providing resources of the router, which are para-virtualized according to a hypervisor, according to the schedule set for each operating system.

The present invention performs para-virtualization for the router such that the router has a processing speed higher than the processing speed when conventional full virtualization is carried out for the router.

When multiple operating systems are installed in the router, the present invention schedules the resources of the router and allocates the resources to the operating systems so as to minimize a decrease in the processing speed of the router due to router virtualization.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic diagram of a router to which a method for forwarding path virtualization for a router according to the present invention is applied;

FIG. 2 is a schematic diagram illustrating a method of driving operating systems in a routing system according to the present invention;

FIG. 3 is a schematic diagram illustrating operating relationship among a forwarding engine, a forwarding virtualization layer and a routing component illustrated in FIG. 2;

FIG. 4 is a flowchart illustrating a method of setting resources of a forwarding engine by a management component;

FIG. 5 illustrates an example of a forwarding information table used in the forwarding engine; and

FIG. 6 is a flowchart illustrating a method of creating resource statistic information for confirming the extent of resources available in the forwarding virtualization layer.

### DETAILED DESCRIPTION OF THE PREFERRED EMBODIMENTS

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements, and thus their description will be omitted.

Hereinafter, an embodiment of the present invention will be described below with reference to the accompanying drawings.

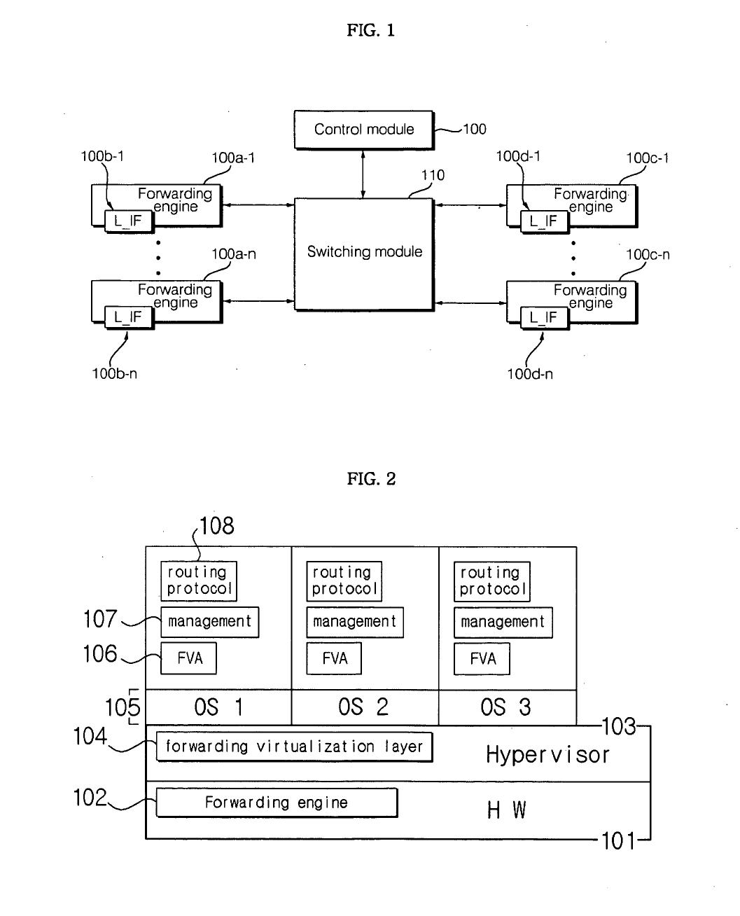

FIG. 1 is a schematic diagram of a router to which a method for forwarding path virtualization for a router according to the present invention is applied.

Referring to FIG. 1, a control module 100 controls the router and collects routing information for packet forwarding of forwarding engines 100a-1 through 100a-n, 100c-1 through 100c-n through a routing protocol. The control module 100 is implemented as a general-purpose processor or ASIC (Application Specific Integrated Circuit) and connected to a volatile memory (DRAM, for example) or a nonvolatile memory to drive operating systems and application programs.

In the current embodiment of the present invention, the control module 100 drives a plurality of operating systems and applications operated by the operating systems and operates a hypervisor such that the plurality of operating systems can use hardware resources (forwarding engines, line interfaces and the control module) constructing the router and resources (a packet transmission rate, the number of flows and an IP address range) related to the performance of the router. The hardware resources and the resources related to the router performance are referred to as “resources” hereinafter.

Although FIG. 1 illustrates that line interfaces 100b-1 through 100b-n and 100d-1 through 100d-n are respectively included in the forwarding engines 100a-1 through 100a-n and 100c-1 through 100c-n, the line interfaces 100b-1 through 100b-n and 100d-1 through 100d-n may be separated from the forwarding engines 100a-1 through 100a-n and 100c-1 through 100c-n.

Here, the forwarding engines 100a-1 through 100a-n and 100c-1 through 100c-n determine a packet destination according to routing information generated by the control module 100. Furthermore, the forwarding engines 100a-1 through 100a-n and 100c-1 through 100c-n may check whether transmitted or received packets are valid.

FIG. 2 is a schematic diagram illustrating a method of driving operating systems in a routing system according to the present invention.

Referring to FIG. 2, a forwarding engine 102 is implemented as hardware and may include a line interface or operate in connection with the line interface, as described above. Although a routing protocol module 108, a management module 107 and a forwarding virtualization abstract (FVA) layer 106 relate to an operating system OS1 105 in FIG. 2, they are applied to other operating systems OS2 and OS3 in the same manner. Accordingly, only the operating system OS1 is described and given a reference numeral hereinafter.

Though Linux operating system and Unix operating system are suitable as the operating system 105, Microsoft Windows operating system can be also used as the operating system 105. The operating system 105 is driven by the control module 100 included in the router illustrated in FIG. 1 and can operate the routing protocol module 108, the management module 107 and the FVA layer 106. The control module 100 may load and execute the routing protocol module 108, the management module 107 and the FVA layer 106 operated by the operating system 105 by using a volatile memory or a nonvolatile memory.

In the current embodiment of the present invention, the hardware elements illustrated in FIG. 1 are controlled by the routing protocol module 108 and the management module 107. The routing protocol module 108 executes a core function of the router and generates forwarding information. The management module 107 performs functions with respect to set-up and management for the router. The forwarding engine 102 which becomes a main target of virtualization for the hardware constructing the router sends packets inputted through a port (not shown) of the router to a corresponding port with reference to a destination address.

A hypervisor 103 corresponds to a virtual platform which allows the control module 100 to drive a plurality of operating systems (Linux, Unix and Windows operating systems).

A forwarding virtualization layer 104 included in the hypervisor 103 functions as a connecting path of the FVA layer 106 and the forwarding engine 102 and allows the operating system 105 to access the forwarding engine 102 through the FVA layer 106 to use resources of the forwarding engine 102.

Here, the operating systems OS1, OS2 and OS3 are not simultaneously connected to the hypervisor 103 and they are selectively connected to the hypervisor if required.

Accordingly, the hypervisor 103 according to the present invention does not full-virtualize the forwarding engine 102 for all the operating systems OS1, OS2 and OS3 located in the upper layer of the hypervisor 103 and connects only an operating system that requires the forwarding engine 102 to the forwarding engine 102.

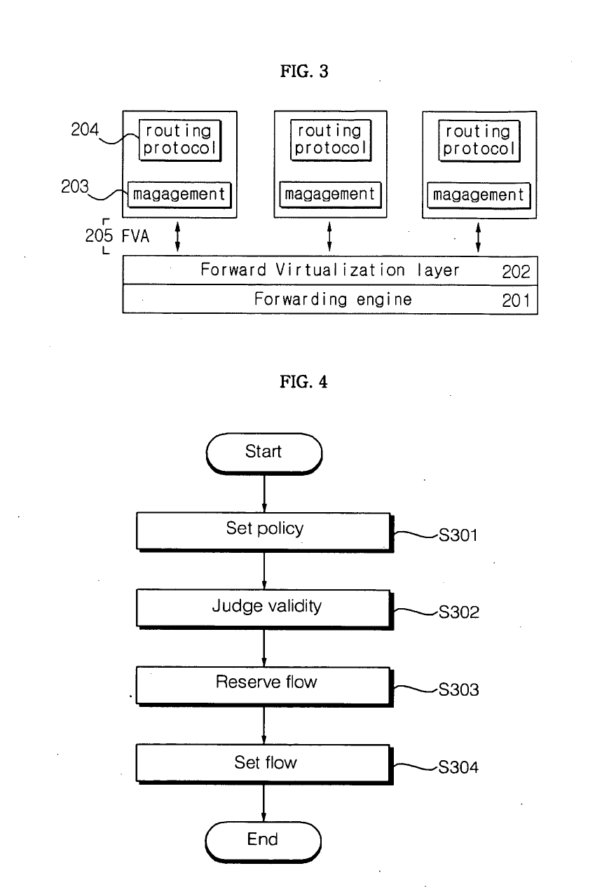

FIG. 3 is a schematic diagram illustrating operating relationship among the forwarding engine, the FVA layer and the routing component illustrated in FIG. 2.

Referring to FIG. 3, a FVA layer 205 allows a routing protocol 204 and a management component 203 to access resources of a forwarding engine 201 through a forwarding virtualization layer 202.

FIG. 4 is a flowchart illustrating a method of setting the resources of the forwarding engine 102 in the management component 107 illustrated in FIG. 1.

The management module 107 sets a policy of using resources of the forward engine 102 to determine which resource will be used among available resources of the forwarding engine 102 and a degree to which the resource is used in step S301. For example, the management module 107 may set the policy by using an IP address information list, the number of flows, a packet transmission rate, etc. among the resources of the forwarding engine 102.

The management module 107 may produce statistic information with reference to details of used resources such as the IP address information list, the number of flows, the packet transmission rate among the resources of the forwarding engine 107 and make a schedule of using the resources based on the statistic information or based statistics of using resources of an application operated by the operating system 105.

Furthermore, the management module 107 may set the policy of using resources by splitting time based on the number of operating systems. In this case, the resources of the forwarding engine 102 are segmented into time units and allocated to the management module 107 included in each operating system and a management component (management module 107, for example) of each of the operating systems OS1, OS2 and OS3 can make a required schedule within a time allocated thereto.

Accordingly, it is required to assign identifiers to the resources of the forwarding engine 102 in order to identify operating systems using the resources. For example, identifiers are assigned to information on the IP address information list range, the number of flows and the packet transmission rate with respect to the resources of the forwarding engine 102 according to the operating system using the information. The identifiers may be assigned in the form of “IP address information list, the number of flows, packet transmission rate and an operating system (one of OS1, OS2 and OS3, for example).

The control module 100 assigns an identifier to the forwarding engine 102 and classifies packets transmitted/received through a switching module 110 according to operating systems or management components belonging to the operating systems.

The control module 100 sets a packet queue according to classification by operating systems (or management components of the operating systems) in step S303 sets scheduling for packets arranged in the packet queue. Here, the forwarding engine 102 determines whether the scheduled packets satisfy resources that can be actually provided by the forwarding engine 102 and meet the policy set by the management component of each operating system in step S302.

The resources of the forwarding engine 102 are monitored at a predetermined time interval. The control module 100 reserves flows by using the set information in step S303. Here, the set information may be a queue size and a classifier. Flow classification is performed by using one of IP addresses and identifiers and the queue size is determined by the packet transmission rate. When the flows are normally set using the aforementioned values in step S304, setting of policy according to the control module 100 is completed.

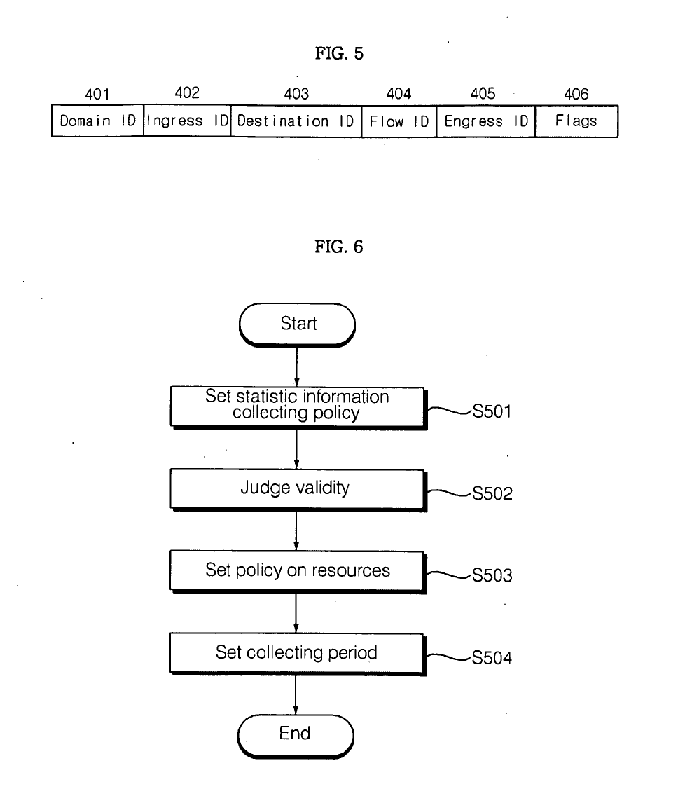

FIG. 5 illustrates an example of a forwarding information table used in the forwarding engine.

A domain ID 401 is used to identify packets inputted from a specific domain and an ingress ID 402 is used to identify an ingress port of a specific domain. A destination ID 403 is used to identify a destination of forwarded packets and a flow ID 404 corresponds to an identifier for identifying a specific flow allocated to a domain. An engress ID 405 is used to identify a packet output port and a flag 406 is a value set when special management is required to process flows and packets, for example, multicast packets or anicast packets.

The forwarding virtualization layer processes API capable of accessing the forwarding information table illustrated in FIG. 5. The routing protocol and management component of each operating system accesses the forwarding information table through the forwarding virtualization layer. The forwarding information table is compatible with API of FORCES recommended by IETF. Accordingly, the forwarding virtualization layer can accept API of FORCES.

FIG. 6 is a flowchart illustrating a method of generating resource statistic information for confirming the extent of resources available in the forwarding virtualization layer.

The control module 100 sets a statistic information collecting policy in step S501 and defines resources that can be virtualized in a router. The resources are determined when a policy with respect to the router is set. For example, flows can be core virtualization resources in the case of a flow based router.

Then, the control module 100 confirms whether the set policy has an error in step S502 and sets the determined policy on the resources when the policy has no error in step S503.

The control module 100 sets a statistic information collecting period in step S504. Here, it is desirable to set the statistic information collecting period in consideration of processing capabilities of the control module 100 and the forwarding engine 102 of the router.

Finally, the control module 100 creates statistic information on packets transmitted and received through the forwarding engine 102 after the statistic information collecting period is set in step S505.

As described above, the present invention can allocate resources of the router, required for virtualization, to operating systems without having additional intervention of a person when virtualization is performed for the router and process packets at a high speed.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for forwarding path virtualization for a router, comprising:
setting a resource using schedule with respect to a forwarding engine of the router for each of a plurality of operating systems; and
providing resources of the router, which are para-virtualized according to a hypervisor, according to the schedule set for each operating system.

2. The method of claim 1, wherein the setting of the resource using schedule for each operating system comprises:
reserving the resources for each operating system;
creating a forwarding table with respect to the forwarding resources;
classifying the resources into packets according to the operating systems;
setting a packet queue for the packets; and
setting packet scheduling for each packet.

3. The method of claim 1, wherein the resources correspond to one of an IP address information range, the number of flows and a packet transmission rate which can be allocated by the router to the operating systems.

4. The method of claim 1, further comprising:
calculating statistic information on resources previously consumed by the operating systems; and
distributing resources for the operating systems based on the statistic information.

5. The method of claim 1, wherein the setting of the resource using schedule for each of the plurality of operating systems comprises allocating a forwarding engine using time to each operating system and allowing each operating system to use the resources within the allocated forwarding engine using time.

6. The method of claim 1, wherein the operating systems use the resources of the forwarding engine after reserving the resources.

7. The method of claim 1, wherein the forward engine is implemented as hardware.
